(19) United States
(12) Patent Application Publication
(10) Pub. No.: US 2007/0220886 A1
(43) Pub. Date: Sep. 27, 2007

(54) Vehicle with a turbocharged diesel engine and exhaust recycling

(75) Inventors: Gernot Tschaler, St. Valentin (AT); Karl Mayr, Behamberg (AT)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/802,078

(22) Filed: May 18, 2007

Related U.S. Application Data
(63) Continuation of application No. PCT/EP05/11330, filed on Oct. 21, 2005.

(30) Foreign Application Priority Data
Nov. 19, 2004 (DE) 10 2004 055 846.9

(51) Int. Cl. F02D 23/00; F02B 33/44

(52) U.S. Cl. 60/605.2; 60/605.1; 60/600

(57) ABSTRACT

Vehicle having a Diesel engine comprising an intake section by means of which fresh air is taken in by a compress of an exhaust gas turbocharger, is compressed and is supplied to the Diesel engine by way of a charge air cooler, and an exhaust system in which exhaust gas flowing out of the Diesel engine drives a turbine of the exhaust gas turbocharger rotationally coupled with the compressor, and the exhaust gas flows through a carbon particle filter behind the turbine. The exhaust system has a branch-off valve which, in the flow direction of the exhaust gas, is arranged behind the carbon particle filter and is in a fluid connection with the intake section. A partial volume flow of the exhaust gas can be fed to the intake section by way of the branch-off valve.

This application is a Continuation of PCT/EP2005/011330, filed Oct. 21, 2005, and claims the priority of DE 10 2004 055 846.9, filed Nov. 19, 2004, the disclosures of which are expressly incorporated by reference herein.

### BACKGROUND AND SUMMARY OF THE INVENTION

The present invention relates to a vehicle having a Diesel engine having a turbocharger and exhaust gas recirculation.

Diesel engines equipped with a turbocharger, a charge air cooler and an exhaust gas recirculation device are the state of the art. Modern Diesel vehicles are increasingly equipped with carbon particle filters. In the case of conventional Diesel engines, the removal of the exhaust gas “branched off” into the intake section normally takes place in front of the exhaust gas turbocharger. The “recirculated” exhaust gas is then normally fed into the intake section behind the charge air cooler. Here, it is a problem that, on the one hand, the recirculated exhaust gas is contaminated by Diesel particles. Since the removal of the exhaust gas to be recirculated takes place in front of the exhaust gas turbocharger, the mass flow rate flowing via the turbine of the exhaust gas turbocharger is reduced. This has a disadvantageous effect on the dynamics of the exhaust gas turbocharger. It is also a disadvantage that, when the exhaust gas is introduced behind the charge air cooler, the charge air cooler cannot be utilized for cooling the exhaust gas.

It is an object of the invention to create a vehicle having a turbo Diesel engine with an improved exhaust gas recirculation device.

The invention is based on a vehicle having a Diesel engine and a turbocharger. As known from the state of the art, the compressor of the turbocharger is arranged in the intake section of the Diesel engine, which compressor takes in fresh air, compresses it and, by way of a charge air cooler, feeds it to the Diesel engine. The turbine of the exhaust gas turbocharger, which is rotationally coupled with the compressor, is arranged in the exhaust gas section of the Diesel engine. In the flow direction of the exhaust gas, a carbon particle filter is arranged behind the turbine of the exhaust gas turbocharger.

It is the essence of the invention that, viewed in the flow direction of the exhaust gas, a “branch-off valve”, in the following also called “scoop valve”, is arranged behind the carbon particle filter. By way of the branch-off valve or scoop valve, a partial exhaust gas volume flow can be removed from the exhaust gas section and can be fed to the intake section. Since the branch-off or scoop valve is arranged behind the carbon particle filter, the exhaust gas fed to the intake section is free of or almost free of carbon particles, which has the advantage that the exhaust gas to be recirculated does not contaminate the intake section. Another advantage is the fact that entire exhaust gas volume flows through the turbine of the exhaust gas turbocharger, so that the kinetic energy of the exhaust gas can be optimally utilized. The exhaust gas branched off by way of the branch-off valve or scoop valve can be fed to the intake section, for example, in front of the compressor. As an alternative, the exhaust gas to be recirculated can also be fed to the intake section directly by way of the compressor housing.

The branch-off valve or scoop valve preferably has an inoperative normal position, in which it tightly closes the fluid connection to the intake section, so that all exhaust gas emitted by the engine can flow unhindered into the exhaust system. As a result of the opening of the branch-off valve or scoop valve, on the one hand, the “exhaust gas recirculating duct”, that is, the fluid connection between the branch-off valve and the intake section is opened more and more, and simultaneously the exhaust gas duct is closed more and more in the direction of the tail pipe, so that the exhaust backpressure is increased and thereby the scavenging gradient and finally the displayable exhaust gas recirculating rate is increased.

In order to reduce the inlet temperature of the recirculated exhaust gas into the intake section or into the compressor, a cooler can be arranged between the “removal point” in the exhaust gas section and the intake section, that is, in the area between the carbon particle filter and the intake section, which cooler cools the recirculated exhaust gas.

According to a further development of the invention, the branch-off or scoop valve and the pipes for recirculating exhaust gas from the exhaust gas section into the intake section as well as the cooler for cooling the recirculated exhaust gas are mounted directly on the particle filter. The exhaust manifold, the exhaust gas turbocharger, the carbon particle filter and the branch-off or scoop valve preferably form a constructional unit which can be pre-assembled or is pre-assembled.

Other objects, advantages and novel features of the present invention will become apparent from the following detailed description of the invention when considered in conjunction with the accompanying drawings.

### BRIEF DESCRIPTION OF THE DRAWINGS

FIG. 1 is a view of a first embodiment of a turbocharged diesel engine with exhaust gas recirculation according to the invention;

FIG. 2 is a view of a second embodiment of a turbocharged diesel engine with exhaust gas recirculation according to the invention;

FIG. 3 is a schematic view of a scoop valve according to the invention;

FIG. 4 is a perspective view of a scoop valve according to the invention;

FIGS. 5a, 5b are views of an embodiment of a valve according to the invention having a flap situated in the center;

FIGS. 6a, 6b are views of an embodiment of a valve according to the invention having rotatably disposed flaps; and

FIG. 7 is a view of an embodiment of a valve according to the invention having a swivellably disposed flap and a pressure compensation device.

### DETAILED DESCRIPTION

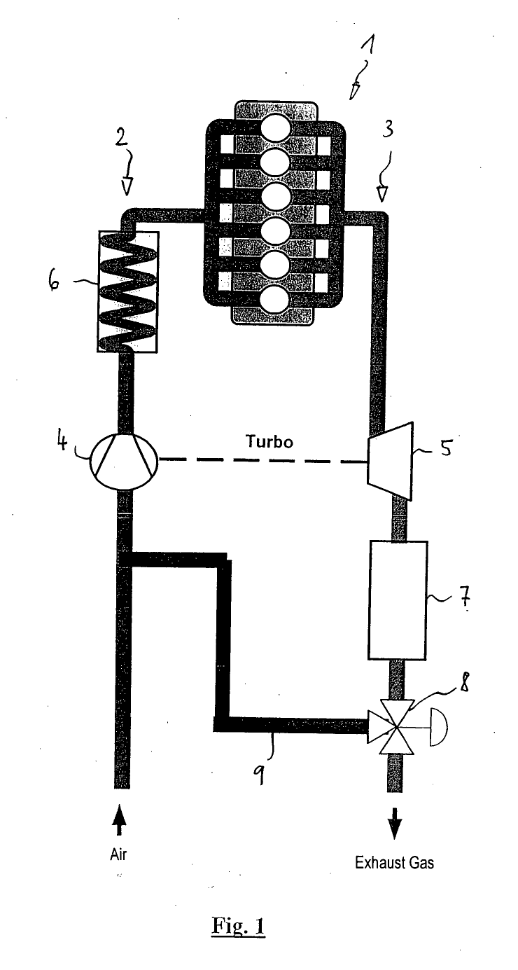

FIG. 1 is a schematic representation of a turbo Diesel engine 1 having an intake section 2 and an exhaust gas section 3. A compressor 4 is arranged in the intake section 2, which compressor 4 is rotationally coupled with a turbine 5 arranged in the exhaust gas section 3. The compressor 4 and the turbine 5 form an exhaust gas turbocharger. Exhaust gas of the Diesel engine 1 flows through the turbine 5 which drives the compressor 4. By way of an air filter, which is not shown here in detail, the compressor 4 takes in fresh air, compresses it and leads the compressed fresh air to the Diesel engine 1 by way of a charge air cooler 6, in which the compressed fresh air is cooled.

In the exhaust gas section 3, a carbon particle filter 7 is arranged behind the turbine 5, which carbon particle filter 7 filters out a large portion of the carbon particles contained in the exhaust gas. Viewed in the flow direction of the exhaust gas, a branch-off or scoop valve 8 is arranged behind the carbon particle filter. The branch-off or scoop valve 8 has a normal position in which the entire exhaust gas volume flow flows out of the exhaust gas section by way of a tail pipe which is not shown here in detail. By means of a connection pipe 9, the branch-off or scoop valve is connected with the intake section 2. Viewed in the intake direction, in the embodiment illustrated here, the connection pipe 9 leads into the intake section in front of the compressor 4. With the increasing opening of the branch-off or scoop valve 8, the flow path to the connection pipe 9 is increasingly opened and the flow cross-section toward the tail pipe is increasingly closed. The scoop valve 8 preferably is an electronically controllable scoop valve whose valve position is controlled as a function of various engine or operating condition parameters. Since the recirculated exhaust gas is removed from the exhaust gas section 3 behind the carbon particle filter 7, it can be supplied without any problem to the intake section in front of the compressor 4 and the charge air cooler 6.

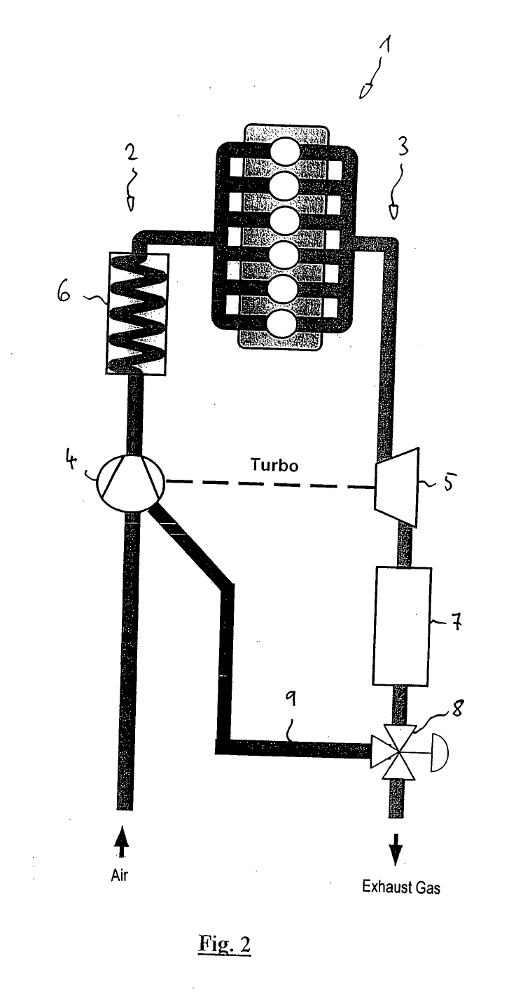

FIG. 2 illustrates a variant of the invention. In contrast to the embodiment of FIG. 1, here, the branch-off or scoop valve 8 is directly connected with the compressor 4 by way of the connection pipe 9. The exhaust gas to be recirculated is therefore introduced into the compressor 4 directly by way of the compressor housing (not shown).

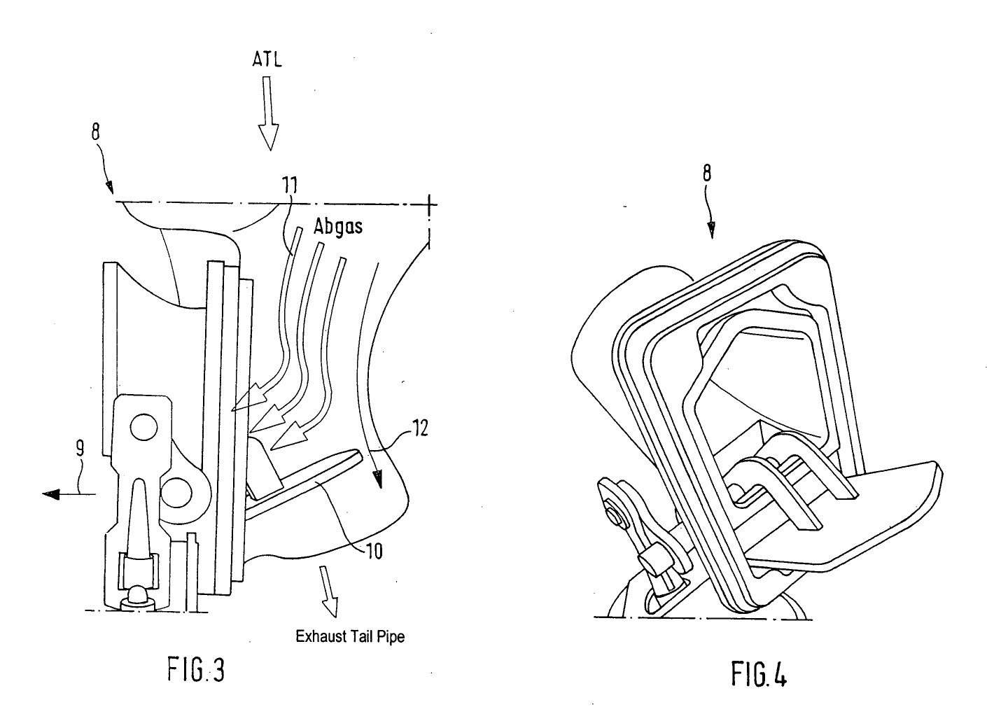

FIG. 3 is a schematic representation of a cross-section of the branch-off or scoop valve 8. The branch-off or scoop valve 8 has a swivellably arranged flap 10. In a normal position, the flap 10 blocks the fluid connection between the exhaust gas section and the connection pipe 9 (compare FIGS. 1, 2). The branch-off or scoop valve 8 can be partially or completely opened by means of an electronic system. When the flap 10 is partially opened, as illustrated in FIG. 3, a partial volume flow 11 of the exhaust gas volume flow is branched off and is supplied to the intake section 2 by way of a connection pipe 9. The residual exhaust gas volume flow 12 flows past the flap 10 in the direction of a tail pipe not shown here in detail.

FIG. 4 is a perspective view of the branch-off or scoop valve 8 of FIG. 3.

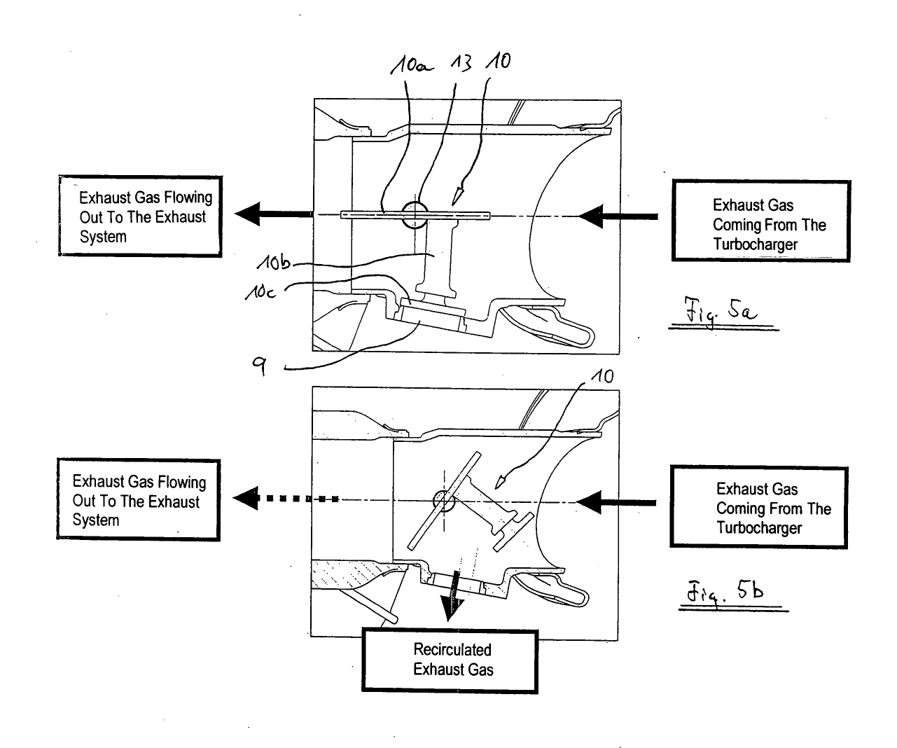

FIGS. 5a and 5b show an embodiment of a branch-off or scoop valve 8, which is constructed as a “flap 10 disposed in the center”. The flap 10 has a first flap wing 10a and a flap arm 10b projecting transversely therefrom, at whose free end a flap plate 10c is arranged. The flap plate 10c is provided for closing the connection pipe 9 (compare FIG. 5a).

The flap 10 is disposed on a swivel pin 13. The swivel pin is connected with the flap wing 10a approximately in the center of the flap wing 10a. As a result, flow forces, which are applied to the flap wing 10a, largely counterbalance one another, so that the flap can be swiveled with low actuating or controlling forces.

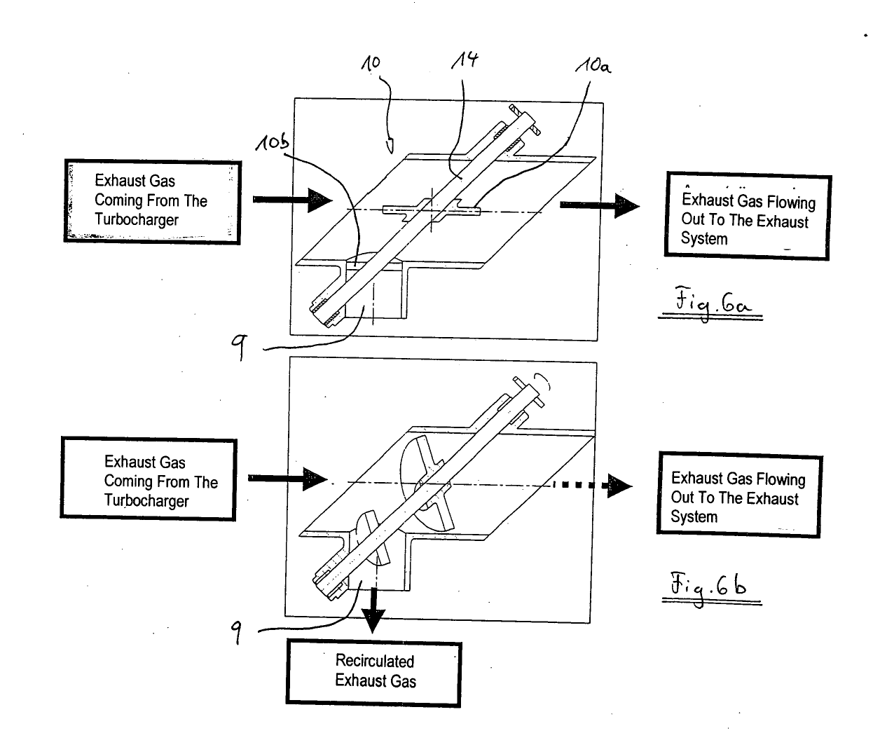

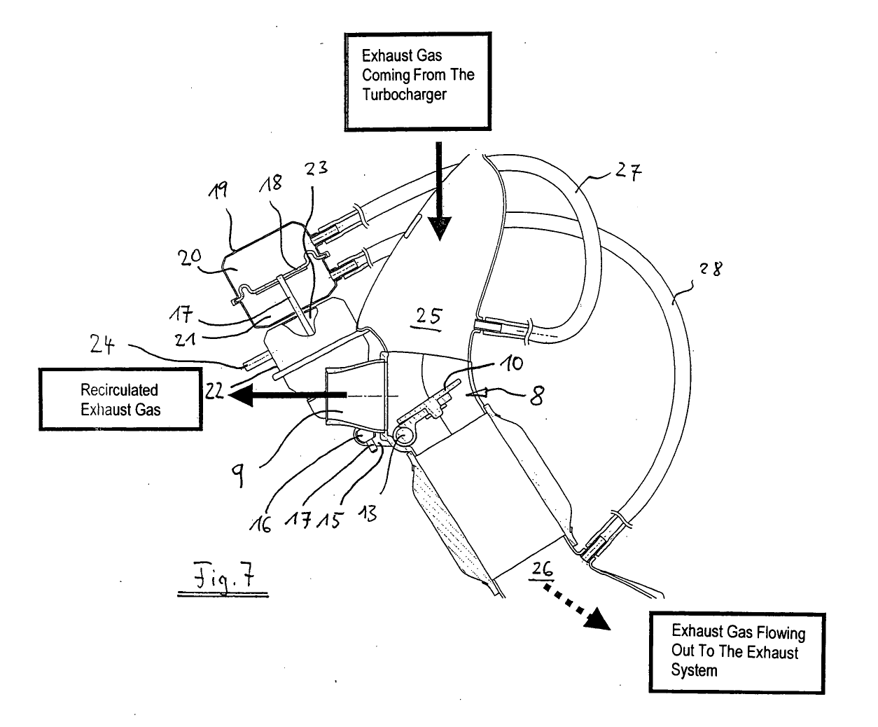

FIGS. 6a and 6b show an embodiment with a rotatably or swivellably arranged double flap. The double flap 10 is disposed by means of a control shaft 14. The control shaft 14 diagonally penetrates the duct connecting the exhaust gas turbocharger with the exhaust system. The double flap 10 has a first flap wing 10a and a second flap wing 10b. The flap wing 10a is provided for closing or opening the duct connecting the exhaust gas turbocharger with the exhaust system. The flap wing 10b is provided for closing or opening the connection duct 9 (compare FIG. 1).

The two flap wings 10a, 10b are not arranged perpendicularly with respect to the control shaft 14 but diagonally with respect to the control shaft; that is, the angle between the control shaft 14 and the planes of the flap wings 10a, 10b are unequal to 90°. In the embodiment illustrated here, the planes of the flap wings 10a, 10b enclose an angle of approximately 45° respectively with the control shaft 14. As a result of the diagonal arrangement of the flap wings 10a, 10b on the control shaft 14, the flow forces are essentially counterbalanced, which permits an adjustment by means of low control forces.

FIG. 7 illustrates an embodiment in which a branch-off or scoop valve 8 is arranged in the exhaust gas duct, which connects the turbocharger 7 (compare FIG. 1) with the exhaust system, which scoop valve 8 is constructed as a swivellable flap 10. In contrast to FIG. 5, at its “end”, the flap 10 is swivellably disposed on a swivel pin 13. In the position illustrated in FIG. 7, the flap 10 is almost completely open. In this open position, the greater part of the volume flow coming from the exhaust gas turbocharger is guided into the connection pipe 9. By way of the connection pipe 9, the “branched-off exhaust gas” is guided into the intake section (compare FIG. 1). When the flap 10 is closed, the exhaust gas duct, which connects the turbocharger 7 (compare FIG. 1) with the exhaust system, is blocked with respect to the connection duct. In this “blocking position”, the exhaust gas coming from the exhaust gas turbocharger is discharged completely into the environment by way of the exhaust system; that is, no exhaust gas is guided to the intake section.

The flap 10 is connected with an adjusting lever 15. The flap 10 can be opened or closed by swiveling the adjusting lever 15. The adjusting lever 15, in turn, is connected in an articulated manner with an adjusting rod 17 by way of a hinge 16. The adjusting rod 17 is connected with the diaphragm 18 of a first pressure box 19 having a first pressure chamber 20 and a second pressure chamber 21. The adjusting rod 17 is also connected with the diaphragm (not visible) of a second pressure box 22 which also, corresponding to pressure box 19, has a first, that is, upper pressure chamber 23 and a second, that is, lower pressure chamber, which, in the representation shown here, is covered by the wall of the second pressure box 22. The adjusting rod therefore extends through the two pressure boxes 19, 22. The first pressure chamber 23 of the second pressure box 22 has a vacuum connection 24, which is connected with the engine (not shown).

The second pressure box 22 is provided for controlling the position of the flap 10. When the vacuum in pressure chamber 23 is large, that is, when the absolute pressure in pressure chamber 23 is low, the pressure existing in the second pressure chamber not visible here presses the diaphragm of the second pressure box and the adjusting rod 10 connected therewith relatively far “upward”. This has the result that the flap 10 is swiveled into the opening position illustrated in FIG. 7. If, inversely, a higher pressure exists in pressure chamber 23, the adjusting rod is displaced downward, which has the result that the flap 10 is closed further or completely.

As illustrated in FIG. 7, in an exhaust gas duct section 25 which, viewed in the flow direction of the exhaust gas, is situated in front of the flap 10, when the flap 10 is open, an excess pressure is created with respect to an exhaust gas duct section 26 which, viewed in the flow direction of the exhaust gas is situated behind the flap 10. When the flap 10 is to be closed, the moment created by the backpressure occurring at the flap 10 therefore has to be overcome. For overcoming this “backpressure moment”, a pressure compensation device is provided which is essentially formed by the first pressure box 19. The first pressure chamber 20 of the first pressure box 19 is connected by way of a hose 27 with exhaust gas duct section 25, which, viewed in the flow direction of the exhaust gas, is situated in front of the flap 10. By way of a hose 28, the second pressure chamber 21 of the first pressure box 19 is connected with exhaust gas duct section 26 which, viewed in the flow direction of the exhaust gas, is situated behind the flap 10. Therefore, when the flap 10 is open (compare FIG. 7), the pressure existing in exhaust gas duct section 25 exists in pressure chamber 20, and the pressure existing in exhaust gas duct section 26 exists in pressure chamber 21. When the flap 10 is open, the pressure in pressure chamber 20 is therefore higher than the pressure in pressure chamber 21. The pressure difference exercises a downward-acting force upon the adjusting rod 17, which force counteracts the “backpressure moment” by way of the lever 15. The backpressure moment is thereby completely or at least partially compensated. The flap 10 can therefore be closed by means of a relatively small closing moment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle having a Diesel engine, comprising:
an exhaust gas turbocharger;
an intake section through fresh air enters a compressor of the exhaust gas turbocharger;
a charge air cooler which receives the fresh air compressed by the compressor and supplies the compressed fresh air to the Diesel engine; and
an exhaust system which receives exhaust gas flowing out of the Diesel engine,
wherein
the exhaust gas drives a turbine of the exhaust gas turbocharger rotationally coupled with the compressor,
the exhaust gas flows through a carbon particle filter downstream of the turbine,
the exhaust system has a branch-off valve downstream of the carbon particle filter which is in fluid connection with the intake section, such that a partial volume flow of the exhaust gas is feedable to the intake section by way of the branch-off valve.

2. The vehicle according to claim 1, wherein
the branch-off valve is connected to the intake section upstream of the compressor of the exhaust gas turbocharger.

3. The vehicle according to claim 1, wherein
the branch-off valve is in direct fluid connection with the compressor by way of a connection pipe.

4. The vehicle according to claim 1, wherein
the branch-off valve has an inoperative normal position, in which the valve closes the fluid connection between the branch-off valve and the intake section.

5. The vehicle according to claim 4, wherein
the branch-off valve has several opening positions, in which as an opening of the branch-off valve increases, a flow cross-section of the fluid connection toward the intake section increases and simultaneously a flow cross-section of the exhaust system toward an outlet of the exhaust system decreases.

6. The vehicle according to claim 5, wherein
the branch-off valve has a valve flap arranged to swivel, such that the swiveling of the valve flap determines the valve opening position.

7. The vehicle according to claim 1, wherein
an exhaust manifold which receives the exhaust gas from the Diesel engine, the exhaust gas turbocharger, the carbon particle filter and the branch-off valve, are mutually connected to form a single exhaust unit.

8. A method of controlling exhaust gas recirculation in a vehicle having a Diesel engine, an exhaust gas turbocharger, an intake section through fresh air enters a compressor of the exhaust gas turbocharger, a charge air cooler which receives the fresh air compressed by the compressor and supplies the compressed fresh air to the Diesel engine, an exhaust system which receives exhaust gas flowing out of the Diesel engine, a carbon particle filter downstream of a turbine of the exhaust gas turbocharger, and a branch-off valve downstream of the carbon particle filter which is in fluid connection with the intake section, comprising the steps of:
operating the Diesel engine;
controlling an opening position of the branch-off valve to achieve a predetermined partial volume flow of the exhaust gas to the intake section.
